(19) United States
(12) Patent Application Publication
(10) Pub. No.: US 2002/0076473 A1
(43) Pub. Date: Jun. 20, 2002

(54) Process for the adaptation of flavor mixtures

(76) Inventors: Gerald Reinders, Salzkotten (DE); Harry Erfurt, Uslar (DE)

Correspondence Address: BAYER CORPORATION, PATENT DEPARTMENT, 100 BAYER ROAD, PITTSBURGH, PA, 15205, US

(21) Appl. No.: 10/023,178

(22) Filed: Dec. 17, 2001

(30) Foreign Application Priority Data
Dec. 20, 2000 (DE) 10063487.7

(51) Int. Cl. A23L 1/22

(52) U.S. Cl. 426/534

(57) ABSTRACT

The present invention relates to a process for the adaptation of flavor mixtures comprising the steps of:

a) selecting or preparing a base matrix comprising a flavor mixture having the desired properties,

b) analyzing the flavor composition and flavor concentration in the headspace above the base matrix,

c) introducing the flavor mixture into another matrix,

d) analyzing the flavor composition in the headspace above the other matrix, and

e) on the basis of the results in step b) and d), changing the flavor composition in the other matrix in such a manner that the flavor properties in the other matrix correspond to those of the base matrix and

f) preparing the novel flavor mixture in accordance with the analytical result and subjecting said flavor mixture to sensory testing.

### FIELD OF THE INVENTION

The present invention relates to a process for the adaptation of flavor mixtures and their use for the modification and optimization of the flavor properties of foods.

### BACKGROUND OF THE INVENTION

The flavor of a food is essentially determined by volatile compounds, in addition to the largely non-volatile taste components (sweet, sour, salty, bitter). The odor-active volatile compounds are perceived retronasally in the Regio olfocatoria, a tissue in the inner upper part of the nose, on the odor receptors (Trends in Food Science and Technology (1996) Vol. 7, 425-431; Food Technology (1997) 51 (1) 75-80).

The composition of one's breath which passes retronasally from the oral cavity to the olfactory epithelium is thus, critical for flavor perception. The volatile compounds are released from the food during chewing in the mouth. The proportion of volatile compounds is determined by phase distribution processes within the food (Nernst distribution) and between food and gas phase in the oral cavity (Henry distribution). In addition, diffusion processes in the food play a critical role for the time course of flavor release (Food Reviews International (1991) 7 (2), 137-184; Flavor Chemistry: 30 years of Progress (1999), 397-405; Fluid Phase Equilibra (1999) 158-160, 657-671; J. Agric. Food Chem. (2000) 48, 1278-1284).

The distribution and diffusion constants differ for each individual flavor compound, so that the composition of the flavor in the vapor phase above the food changes with the composition and structure of the food. Thus, a flavor must be developed separately for each food, that is to say adapted to this.

Numerous publications exist on the topic “interactions between flavor and food” and on the topic “release of flavors during chewing”. Generally, the effects of food constituents have been considered and discussed in isolation. Although the purpose of scientific work has been declared to be the application of a flavor profile to a food, no methods are known to date by which the flavors can be adapted.

In purely theoretical work (International Journal of Food Science and Technology (1995) 30, 425-436, Journal of Food Science (1997) 62 (4) 653-658 und 664; International Journal of Food Science and Technology (1997) 32, 1-9, J. Agric. Food Chem. (1997) 45, 1883-1890, J. Agric. Food Chem. (1998) 46, 2727-2743), although a comprehensive mathematical model on the release of flavor in the mouth has been developed for years, flavor adaptation to the food matrix is not yet being considered. In the publication by Kris B. de Roos and Kees Wolswinkel, in addition, a “Non-equilibrium partion model for predicting flavor release in the mouth” is described (Trends in Flavor Research (1994) 15-32).

### SUMMARY OF THE INVENTION

The object of the present invention is now to provide a process with which a flavor profile from one matrix can be applied to another matrix. It must be ensured here that the flavor composition is altered as a function of the composition and structure of the other matrix and thus, precise adaptation to the altered physical properties in the other matrix is achieved.

A process for the adaptation of flavor mixtures has been found which is characterized in that

a) a base matrix comprising a flavor mixture having the desired properties is selected or prepared,

b) the flavor composition and flavor concentration in the headspace above the base matrix is analyzed,

c) the flavor is introduced into another matrix,

d) the flavor composition and flavor concentration in the headspace above the other matrix is analyzed, and

e) on the basis of the analytical results in step b) and d) the flavor composition in the other matrix is changed in such a manner that the flavor properties in the other matrix correspond in terms of sensory properties to those of the base matrix.

### DETAILED DESCRIPTION OF THE INVENTION

The principle of the inventive process is based on the fact that first, a base having a flavor matched is selected that has the desired properties. That is to say especially, the sensory properties of the flavor must be tested. The base matrix can be an artificial model system or a customary food.

The composition of the volatile constituents in the headspace above the base matrix is then analyzed. This is preferably performed in equilibrium by static headspace gas chromatography.

The same flavor is then incorporated into another matrix. This matrix is also preferably a food which is to be given novel flavor properties. That is to say in the inventive process a flavor mixture is prepared in which the composition of the volatile flavor constituents in the headspace over the matrix corresponds to that of the base matrix.

The analysis can be carried out according to the present invention using all known methods. Preference is given to static headspace gas chromatography and mass spectrometry.

A more preferred embodiment according to the present invention is the use of static headspace gas chromatography. In this method analysis is performed on the basis of the peak areas. The peak areas of all identified flavor constituents are normalized to a total of 100% (peak area percentages).

On the basis of the analytical results for the base matrix and the other matrix, the flavor compounds are adapted to the other matrix. This is necessary, since the distribution and diffusion constants are different for each individual flavor compound. The consequence is that the composition of the flavor in the vapor phase above the food changes with the composition and structure of the food. As a result the sensory properties alter with an altered structure and composition of the food. Thus, for each matrix, that is to say for each food, a flavor must be developed separately, that is to say adapted. It is not sufficient simply to introduce a flavor suitable for a defined matrix (that is to say food) into another matrix, that is to say another food.

Therefore, it is necessary according to the present invention, on the basis of the analytical results for base matrix and other matrix to achieve an adaptation of the composition for the other matrix.

In a preferred form according to the present invention, correction factors are determined. Suitable for use as these are, in particular, the results of static headspace gas chromatography. To calculate the correction factor for each individual flavor compound, the quotient of the peak area percentage of the flavor compound in the base with the peak area percentage of the aroma compound in the new matrix is formed. Aroma compounds, which are not detected receive a correction factor of 1.

In addition, the composition (percent by mass) of the flavor mixture is converted via the respective molar masses into the numbers of moles of the individual flavor compounds. Then, each molar value is multiplied by the corresponding correction factor. These corrected mole fractions are normalized to a total of 1.00 (mole fractions of the adapted flavor mixture) and converted via the respective molar masses to mass ratios. The adapted flavor is mixed in a mass ratio such that the total mass again corresponds to the original base flavor.

The flavor, thus adapted, is incorporated into the new matrix. This can then be analyzed in turn by static headspace gas chromatography in order to check the result of the flavor adaptation. For this, again, the peak area values of the individual flavor compounds can be normalized to 100%. The adaptation can be considered to be successful if the headspace profile (peak area percentages) agrees with the headspace profile of the base matrix.

Finally, what is termed the intensity factor may be determined. This is calculated as a quotient from the sum of the peak area values of all flavor compounds in the headspace of the base matrix and the total of the peak area values of all flavor compounds in the headspace of the other matrix. The intensity of the flavor is adapted by multiplying the amount of flavor added by the intensity factor.

As a further check of the adaptation, a triangle sensory test can be carried out.

By means of the present inventive process, it is possible to apply a flavor profile of a food to another food. A prerequirement is that the formula of the flavor is completely known qualitatively. The content of each individual flavor compound of an aroma is adapted by using correction factors, so that a completely new flavor formula results which is tailor-made to the new product. The correction factors may be determined, for example, from static headspace gas chromatography measurement. In this case, only the high-volatility to medium-volatility flavor substances are determined; therefore, possibly, fine adaptation by a flavorist is accordingly necessary for the region of the higher-boiling constituents. In addition to the profile, the intensity of the flavor is also adapted. The result of adaptation can be checked by sensory (for example by tasting) and analytical means. Surprisingly, using this inventive process, flavor adaptation can be carried out considerably faster and more goal-oriented, than by a purely flavoristic/sensory approach.

The invention is described in more detail below with reference to examples.

The base matrix used was an acidic sugar solution which was flavored. The composition of the volatile flavor substances in the headspace above the sugar solution was analyzed by static headspace gas chromatography. Overall, base matrices having a peach flavor and three strawberry flavors were prepared and analyzed.

The other matrices selected were yogurts, more precisely full-fat and light yogurts.

The flavors were incorporated unchanged into the yogurt matrices. Then, in each case, the composition of the volatile flavor compounds was analyzed in the headspace above the respective matrix by static headspace gas chromatography.

On the basis of the quotients of the peak area percentages of the flavor compounds in the headspace above the acidic sugar solution and the peak area percentages of the flavor compounds in the headspace above the yogurt matrices, the correction factors were then calculated.

Finally, the number of moles in the flavor mixtures were calculated. These were then multiplied by the correction factors and then normalized to the total of 1 (molar fractions).

On the basis of the molar fractions then determined, the mass ratios were then calculated via the respective molar masses. Then, in accordance with the mass ratios, novel flavor mixtures were prepared which correspond to the total masses of the original base flavors.

The flavor mixtures thus adapted were incorporated into the respective yogurt matrices. As a check, static headspace gas chromatography measurements were again carried out. The area values of the individual flavor compounds were normalized to 100%. In all cases, the adaptations were successful, which was verified by comparing the normalized peak areas with those of the acidic sugar solution and corresponding sensory comparisons.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the adaptation of flavor mixtures, comprising the steps of:
a) selecting or preparing a base matrix comprising a flavor mixture having the desired properties,
b) analyzing the flavor composition and flavor concentration in the headspace above the base matrix,
c) introducing the flavor mixture into another matrix,
d) analyzing the flavor composition in the headspace above the other matrix, and
e) on the basis of the results in step b) and d), changing the flavor composition in the other matrix in such a manner that the flavor properties in the other matrix correspond to those of the base matrix and
f) preparing the novel flavor mixture in accordance with the analytical result and subjecting said flavor mixture to sensory testing.

2. A process according to claim 1, comprising the additional steps of
a) calculating a correction factor from the peak area percentages of the analysis of the base matrix and the other matrix,
b) calculating the number of moles of the individual flavor compounds in the flavor mixture,
c) on the basis of the correction factors determined in step a), adapting the flavor mixture to the other matrix.

3. A process according to claim 1, wherein the volatile constituents of the flavor mixture in the headspace above the matrix are determined.

4. A process according to claim 1, wherein the analysis are carried out by means of static headspace gas chromatography.

5. A process according to claim 4, wherein the peak area values determined by gas chromatography for the flavor compounds in the headspace over the base matrix and for the flavor compounds in the headspace over the other matrix are used to form a quotient for calculating the correction factors.

6. A process according to claim 1, wherein the adapted novel flavor mixture is introduced into the other matrix at a concentration such that the peak area total of the flavor compounds in the headspace over the matrix corresponds to that of the base matrix.

7. A process according to claim 1, wherein the matrices are foods, cosmetics and requisites.

8. A flavor mixture produced from a process for the adaptation of flavor mixtures, comprising the steps of:
a) selecting or preparing a base matrix comprising a flavor mixture having the desired properties,
b) analyzing the flavor composition and flavor concentration in the headspace above the base matrix,
c) introducing the flavor mixture into another matrix,
d) analyzing the flavor composition in the headspace above the other matrix, and
e) on the basis of the results in step b) and d), changing the flavor composition in the other matrix in such a manner that the flavor properties in the other matrix correspond to those of the base matrix and
f) preparing the novel flavor mixture in accordance with the analytical result and subjecting said flavor mixture to sensory testing.
